(19) United States
(12) Patent Application Publication
(10) Pub. No.: US 2020/0210756 A1
(43) Pub. Date: Jul. 2, 2020

(54) 3D Refinement Module for Combining 3D Feature Maps

(71) Applicant: Shenzhen Malong Technologies Co., Ltd., Shenzhen (CN)

(72) Inventors: Xiaojun Hu, Shenzhen (CN); Weilin Huang, Shenzhen (CN); Sheng Guo, Shenzhen (CN); Matthew Robert Scott, Shenzhen (CN)

(21) Appl. No.: 16/693,250

(22) Filed: Nov. 23, 2019

Related U.S. Application Data
(63) Continuation of application No. PCT/CN2018/125354, filed on Dec. 29, 2018.

(51) Int. Cl. G06K 9/62; G06T 7/11; G06T 7/00; G06T 15/08; G06T 5/00; G06T 5/20; G06T 3/40

(52) U.S. Cl. CPC G06K 9/629; G06T 7/11; G06T 7/0012; G06T 15/08; G06T 5/002; G06K 2209/05; G06T 3/40; G06T 2207/20084; G06T 2207/30016; G06T 2207/30096; G06T 5/20

(57) ABSTRACT

Embodiments of the present invention provide systems, methods, and computer storage media for 3D segmentation. A 3D segmentation network can perform a voxel-wise classification of a 3D volume such as a brain tumor. The 3D segmentation network can accept a plurality of 3D representations of the 3D volume (e.g., MRI modalities) into corresponding 3D input channels. Generally, 3D convolutions can be applied by convolutional layers of the 3D segmentation network. Convolutional blocks can generate successive resolutions of feature maps from the plurality of 3D representations by downsampling outputs from prior convolutional blocks. The feature maps can be upsampled and combined to aggregate local and global detail from multiple resolutions. A multi-class classifier can be applied to each voxel at the output layer to generate a voxel-wise prediction map with the same spatial size as the inputs.

### CROSS-REFERENCE TO RELATED APPLICATION

This application is a continuation of International Application No. PCT/CN2018/125354, filed Dec. 29, 2018.

### BACKGROUND

Image segmentation is the process of dividing an image into multiple segments, usually to locate objects and boundaries in the image. Similarly, 3D segmentation is the process of dividing a 3D volume into multiple regions, usually to locate objects and boundaries in the 3D volume. For example, brain tumor segmentation involves identifying the different types of tumor tissues (solid or active tumor, edema, and necrosis) and separating those regions from normal brain tissues (gray matter, white matter, and cerebrospinal fluid). Generally, 3D segmentation has a growing number of practical applications, both within the medical field and elsewhere.

### SUMMARY

Some embodiments of the present disclosure are directed to a 3D segmentation network that performs a voxel-wise classification of a 3D volume such as a tumor. The 3D segmentation network can accept a plurality of 3D representations of the 3D volume (e.g., multiple magnetic resonance imaging (MRI) modalities) into corresponding 3D input channels. Generally, 3D convolutions can be applied by convolutional layers of the 3D segmentation network (e.g., with a kernel size of 3×3×3). Convolutional blocks can generate successive resolutions of feature maps from the plurality of 3D representations by downsampling outputs from prior convolutional blocks. A 3D refinement module can be applied to upsample the feature maps and automatically aggregate local and global detail from multiple resolutions. The 3D refinement module can be applied recursively to upsample the feature maps to the original resolution. As such, a multi-class classifier can be applied to each voxel at the output layer of the 3D segmentation network to generate a voxel-wise prediction map with the same spatial size as the inputs. In this manner, the 3D segmentation network can perform a 3D segmentation without the need for post-processing.

Various training techniques can be implemented to improve the performance of a 3D segmentation network, including the use of focal loss and data augmentation in a designated learning curriculum. In one example of a multi-phase learning curriculum, a 3D segmentation network can be trained on original data in one phase without data augmentation or focus loss. In another phase, data complexity can be increased by applying data augmentation to original videos (e.g., with probability of 50%). In another phase, the 3D segmentation network can be learned using harder samples by employing focal loss with stronger data augmentation (e.g., applied to 75% of training volumes). In this manner, a multi-stage learning curriculum with increasing data complexity can improve the accuracy of the 3D segmentation network.

As such, using implementations described herein, 3D segmentation can be achieved more efficiently and effectively than in prior techniques. For example, the 3D segmentation network described herein with focal loss can lead to improved performance in identifying certain classes of tumor (e.g., enhancing tumor) and certain merged classes (e.g., tumor vs healthy tissue).

Further, in conventional 2D or 3D segmentation pipelines, some complementary post-processing techniques (e.g., conditional random fields (CRFs)) are required to refine coarse results (e.g., when the spatial size of the prediction map is less than the input). However, the 3D segmentation network described herein can achieve 3D segmentation results comparable to or even better than the conventional systems with cumbersome post-processing techniques. As such, the disclosed technology results in a faster, more efficient approach than prior techniques and enables real-time applications.

Some embodiments of the present disclosure are directed to a 3D refinement module. In order to achieve a dense (e.g., voxel-wise) 3D segmentation, a 3D refinement module may be used to align the spatial shape of convolutional features to the input volume. A convolutional feature can be seen as a multidimensional array, and its shape may be composed by a number of channels and a spatial shape. The number of channels may be related to a single voxel. The spatial shape may be related to the shape of the input volume.

To align the spatial shape of convolutional features to the input volume, instead of simply upsampling feature maps, the 3D refinement module can combine feature maps of different resolutions. For example, the 3D refinement module can include an adaptive layer, an upsampling layer, and an element-wise summation. Generally, the adaptive layer reshapes feature maps by changing the number of 3D channels to some predetermined numbers. In some embodiments, the adaptive layer can be implemented using a 1×1×1 kernel. By reshaping feature maps at all resolutions to some common number of 3D channels, feature maps of different resolutions can be combined using an element-wise summation.

In some embodiments, the 3D refinement module can include a smoothing layer, which may be implemented to reduce undesirable artifacts in combined feature maps. As such, the 3D refinement module can be used to upsample feature maps without loss of local detail such as fine structures that normally accompanies upsampling operations, and combine. In this manner, local and global detail can be combined, improving the accuracy of segmentation.

In some embodiments, a 3D refinement module can be applied recursively in a 3D segmentation network to combine feature maps of successive resolutions. For example, a 3D refinement module can be applied to a plurality of convolutional blocks in a 3D segmentation network, to recursively encode local and global information (e.g., in spatial, temporal, or spatiotemporal domains). In some embodiments, the 3D refinement module is configured to align feature maps of different resolutions to the same number of 3D channels. As such, a multi-class classifier can be applied to the output, for example at each voxel, to achieve an accurate, high resolution 3D segmentation.

### BRIEF DESCRIPTION OF THE DRAWINGS

The present invention is described in detail below with reference to the attached drawing figures, wherein:

FIG. 1 is a block diagram of an example 3D segmentation network, in accordance with embodiments of the present invention;

FIG. 2 is a block diagram of an example 3D refinement module, in accordance with embodiments of the present invention;

FIG. 3 is a block diagram of an example tumor 3D segmentation network that can be used to detect tumors from Mills, in accordance with embodiments of the present invention;

FIG. 4 is a flow diagram showing a method for generating voxel-wise segmentation of a 3D volume, in accordance with embodiments of the present invention;

FIG. 5 is a flow diagram showing a method for generating voxel-wise segmentation of tissues, in accordance with embodiments of the present invention;

FIG. 6 is a flow diagram showing a method for combining 3D feature maps of different resolutions, in accordance with embodiments of the present invention;

FIG. 7 is a flow diagram showing a method for combining 3D feature maps of different resolutions, in accordance with embodiments of the present invention; and

FIG. 8 is a block diagram of an exemplary computing environment suitable for use in implementing embodiments of the present invention.

### DETAILED DESCRIPTION

### Overview

Accurate tumor segmentation from MRI images is of great importance for improving cancer diagnosis, surgery planning, and prediction of patient outcome. Manual segmentation of tumors is highly expensive, time-consuming, and subjective. Efforts have been devoted to developing automatic methods for this task, but it is still challenging to precisely identify some tumors (e.g., gliomas and glioblastomas), which are often diffused, poorly contrasted, and have boundaries that are easily confused with healthy tissues. Furthermore, structural tumor regions, such as necrotic core, edema, and enhancing core can appear in any location of the brain with various size and shape, making it particularly difficult to segment them accurately. To improve performance, multiple MRI modalities, such as T1, T1-contrast, T2, and Fluid Attenuation Inversion Recovery (FLAIR), are often utilized to provide richer visual information, and automatic methods have been developed to explore the multiple MRI modalities.

Prior techniques generally pose tumor segmentation as a semantic segmentation task, which produces a dense classification at the pixel level. In these techniques, hand-crafted features are designed for use by a classifier. Generally, hand-crafting features and training the classifier are separate processes, such that the classifier does not impact the nature of the designed features. Some recent techniques use deep convolutional neural networks (CNNs) to generate hierarchical, learned features from MRIs, allowing the features to be learned jointly and collaboratively with an integrated classifier.

However, recent CNN approaches for tumor segmentation often suffer from several common limitations that negatively impact their performance. For example, although CNNs are powerful tools that can generate high-level context features using hierarchical designs, they generally involve multiple pooling operations that require significant downscaling of the resulting feature maps. This downscaling through the hierarchical convolutional layers results in a significant loss of fine structures and other local information, which is critical to accurate segmentation. As such, the accuracy of conventional CNN approaches for tumor segmentation is limited. Moreover, segmentation often involves dense training and inference (i.e., on a per pixel/voxel basis). However, when training samples are highly correlated with neighboring pixels/voxels, significant data imbalance often occurs between the various classes and the background. These limitations make it difficult to train a high-performance 3D segmentation model.

One prior technique involved the use of fully convolutional networks (FCN) for tumor segmentation on 2D MRI slices. In that technique, a two-phase training procedure and cascaded architecture were developed to address class imbalance. Another technique applied boundary-aware FCN to incorporate boundary information. However, these approaches were designed for 2D segmentation of individual MRI slices. Generally, application to 3D volumes increases computational complexity, and using fully convolutional networks limits the accuracy of the segmentation task. Yet another prior technique applied 3D CNNs to lesion segmentation on 3D MRIs. This technique focused on integrating features that were learned from multiple MRI modalities. Another technique proposed a dual pathway 3D CNN that aggregates multi-level features, and the results were refined using a conditional random field. However, such multiple-model solutions result in limited efficiency and accuracy. As such, there is a need for improved techniques for aggregating meaningful spatiotemporal information from multi-modality 3D MRIs.

Accordingly, some embodiments of the present disclosure are directed to a 3D segmentation network that performs a voxel-wise classification of a 3D volume such as a brain tumor. The 3D segmentation network can accept a plurality of 3D representations of the 3D volume (e.g., all four MRI modalities, other 3D images or 3D imaging information, etc.) into corresponding 3D input channels. Generally, 3D convolutions can be applied by convolutional layers of the 3D segmentation network (e.g., with a kernel size of 3×3×3). Convolutional blocks can generate successive resolutions of feature maps from the plurality of 3D representations by downsampling outputs from prior convolutional blocks. A 3D refinement module can be applied to upsample the feature maps and automatically aggregate global detail (e.g., edges, dominant lines, etc.) and local detail (e.g., fine structures, textures, etc.) from multiple resolutions. The 3D refinement module can be applied recursively to upsample the feature maps to the original resolution. As such, a multi-class classifier can be applied to each voxel at the output layer of the 3D segmentation network to generate a voxel-wise prediction map with the same spatial size as the inputs. In this manner, the spatial resolution of the last convolutional layer may be amplified and aligned to that of the input volume

In order to achieve a dense (e.g., voxel-wise) 3D segmentation, a 3D refinement module can align the spatial shape of convolutional features to the input volume. In some embodiments, the alignment in this context includes upscaling the feature map and producing higher resolution predictions. Upsampling is one way of upscaling the feature map. The 3D refinement module as disclosed improves single upsampling. To accomplish such alignment, instead of simply upsampling feature maps, the 3D refinement module can combine feature maps of different resolutions. For example, the 3D refinement module can include an adaptive layer and an upsampling layer, and can apply an element-wise summation. Generally, the adaptive layer reshapes feature maps by changing the number of 3D channels to some predetermined number, e.g., 128 or any suitable number. In some embodiments, the adaptive layer can be implemented using a 1×1×1 kernel. Other possible configurations for the adaptive layer include non-local operations, dilated convolutions, an inception architecture, or otherwise. By reshaping feature maps at all resolutions to some common number of 3D channels, feature maps of different resolutions can be combined using an element-wise summation. In some embodiments, the 3D refinement module can include a smoothing layer, which may be implemented to reduce undesirable artifacts in combined feature maps. As such, the 3D refinement module can be used to upsample feature maps without loss of local detail such as fine structures that normally accompanies upsampling operations. In this manner, local and global detail can be combined, improving the accuracy of segmentation.

In some embodiments, a 3D refinement module can be applied recursively in a 3D segmentation network to combine feature maps of successive resolutions. For example, the 3D refinement module may align a first feature map having a first resolution with a second feature map having a second resolution, wherein the second resolution is higher than the first resolution. In other words, the 3D refinement module can align a low resolution feature map with a high resolution feature map. By way of example, a 3D refinement module can be applied to a plurality of convolutional blocks in a 3D segmentation network to recursively encode local and global information (e.g., in spatial and/or temporal domains). In some embodiments, the 3D refinement module is configured to align feature maps of different resolutions to the same number of 3D channels. As such, a multi-class classifier can be applied to the output, for example at each voxel, to achieve an accurate, high resolution 3D segmentation.

In the context of tumor segmentation, a 3D segmentation network can be configured to classify each voxel, such as to label a voxel as normal tissue or a type of tumor tissue based on one or more MRI modalities (e.g., T1, T1-contrast, T2, and FLAIR). In one embodiment, five labels are used, including the normal tissue and four abnormal tissues (i.e., necrotic core, edema, non-enhancing and enhancing core). A 3D MRI can be generated in any manner (e.g., stacking slices across spatial and/or temporal domains). For example, a 3D volume can be constructed from images of the same location of an organ over time (temporal domain), from images of different locations of an organ at a particular time (spatial domain), or some combination thereof (spatiotemporal domain).

Further, the 3D segmentation network can include a 3D refinement module applied recursively to feature maps from successive convolutional blocks. As such, the 3D segmentation network can achieve a 3D segmentation using a single CNN. Unlike prior techniques with different architectures, the present 3D segmentation network can output a more accurate voxel-wise segmentation of various tumor tissues from 3D MRIs without any post-processing. Furthermore, since post-processing is not necessary, the 3D segmentation task can be performed in about 0.5 s, orders of magnitude faster than in prior techniques. Given the dramatic increase in speed, the present 3D segmentation network facilitates real-time 3D segmentation.

In some embodiments, various training techniques can be applied to improve the accuracy of the 3D segmentation network. Generally, the 3D segmentation network can replace cross-entropy loss with focal loss as the minimization function in the softmax classifier, in certain circumstances, to automatically select a spare set of meaningful samples for learning. Various data augmentation techniques can be applied to increase data complexity where training data is limited. These concepts can be applied in a learning curriculum in which data complexity is increased gradually. One example curriculum includes three phases. In the first phase, the 3D segmentation network can be trained on original data without data augmentation or focus loss. In a second phase, data complexity can be increased by applying data augmentation to original videos (e.g., with probability of 50%). In a third phase, the 3D segmentation network can be learned using harder samples by employing focal loss with stronger data augmentation (e.g., applied to 75% of training volumes). In this manner, a multi-stage learning curriculum with increasing data complexity can improve the accuracy of the 3D segmentation network.

As such, using implementations described herein, 3D segmentation can be achieved more efficiently and effectively than in prior techniques. For example, the 3D segmentation network described herein with focal loss can lead to improved performance in identifying certain classes of tumor (e.g., enhancing tumor) and certain merged classes (e.g., tumor vs healthy tissue). Furthermore, the 3D segmentation network described herein can achieve 3D segmentation without post-processing. As such, this single-shot model results in a faster, more efficient approach than prior techniques, and can be applied to real-time applications.

### Example 3D Segmentation Network

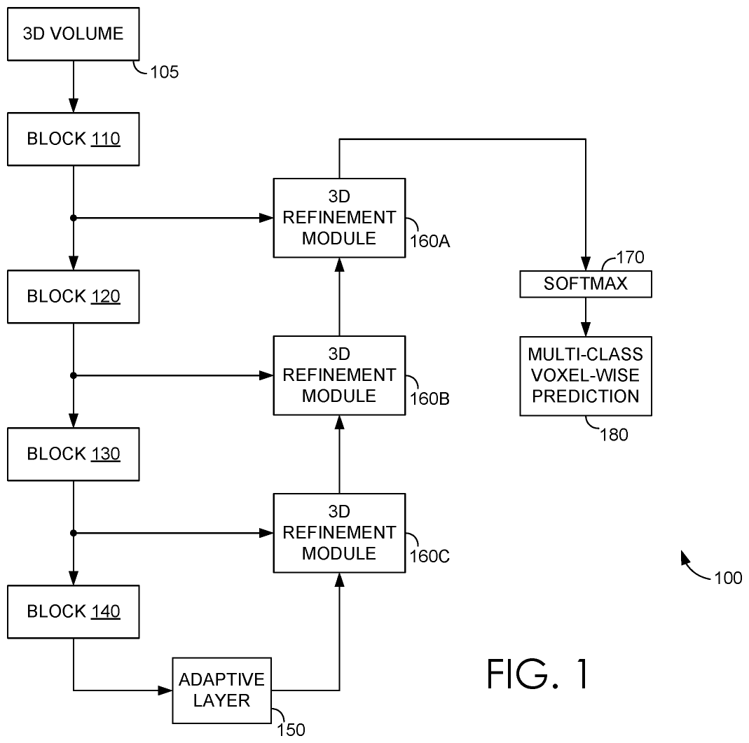

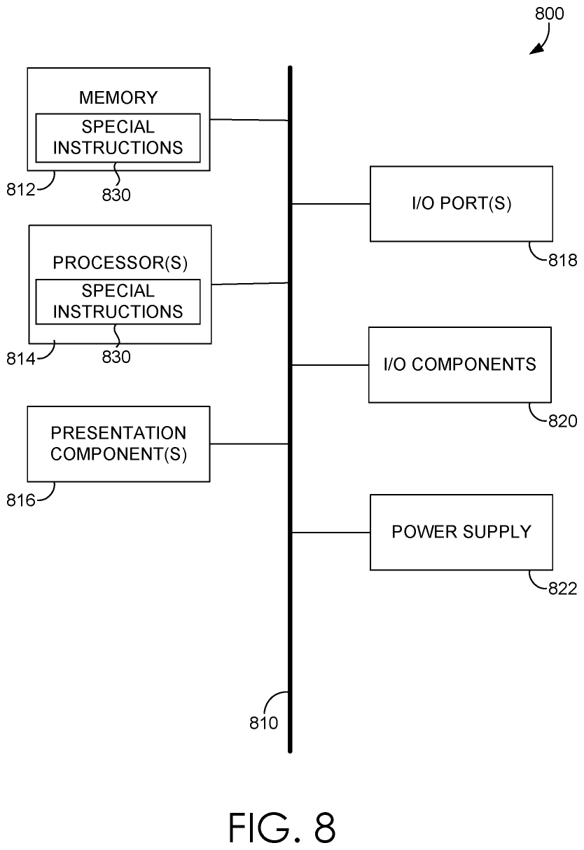

Referring now to FIG. 1, a block diagram of example 3D segmentation network 100 is shown. Generally, 3D segmentation network 100 can be implemented in any suitable computing environment. For example, 3D segmentation network 100 may be implemented on one or more computing devices capable of facilitating a voxel-wise 3D segmentation. For example, in an embodiment, 3D segmentation network 100 may be implemented on a computing device such as computing device 800, as described below with reference to FIG. 8. In various embodiments, the computing device can be a personal computer (PC), a laptop computer, a workstation, a mobile computing device, a PDA, a cell phone, or the like.

In the embodiment illustrated in FIG. 1, 3D segmentation network 100 includes convolutional blocks 110, 120, 130, 140; adaptive layer 150; 3D refinement modules 160A, 160B, 160C; and softmax classifier 170. The components of 3D segmentation network 100 are communicatively coupled as illustrated in FIG. 1. In embodiments in which the components of 3D segmentation network 100 are located on different computing devices, the components may communicate via a network, which may include, without limitation, one or more local area networks (LANs) and/or wide area networks (WANs). Such networking environments are commonplace in offices, enterprise-wide computer networks, intranets, and the Internet.

Generally, 3D segmentation network 100 may be incorporated, or integrated, into an application or an add-on or plug-in to an application. The application may generally be any application capable of facilitating 3D segmentation. The application may be a stand-alone application, a mobile application, a web application, or the like. In some implementations, the application(s) comprises a web application, which can run in a web browser, and could be hosted at least partially server-side. In addition, or instead, the application(s) can comprise a dedicated application. In some cases, the application can be integrated into the operating system (e.g., as a service).

Generally, 3D segmentation network 100 includes a convolutional neural network with a plurality of convolutional layers implemented in blocks 110-140 and 3D refinement modules 160A-C. At a high level, 3D segmentation network 100 accepts multiple modalities of a 3D volume 105 as an input. More specifically, block 110 may accept the multiple modalities as an input by considering each modality as a 3D channel. Block 110 downsamples the inputs from its 3D input channels to generate 3D feature maps in each of a plurality of 3D output channels. Successive blocks are configured to downsample the 3D feature maps from prior blocks, generating successive resolutions of 3D feature maps. 3D refinement modules 160A-C generally upsample the 3D feature maps (e.g., by performing a backwards convolution) and recursively combine 3D feature maps of different resolutions, as illustrated in FIG. 1. Generally, 3D convolutions can be applied by any number of convolutional layers, and with any suitable kernel size (e.g., 3×3×3).

To facilitate combining 3D feature maps of different resolutions, an adaptive layer (e.g., adaptive layer 150) can be applied to reshape the feature maps by changing the number of 3D channels to some predetermined number, e.g., 128 or another suitable number. In various embodiments, the adaptive layer produces an output feature which has the same spatial resolution as the input feature but with a predetermined channel number. For example, an adaptive layer can be applied to the output of each of convolutional blocks 110-140. In the embodiment illustrated in FIG. 1, adaptive layers are incorporated in each of 3D refinement modules 160A-C. In some embodiments, the adaptive layer can be implemented using a 1×1×1 kernel. Other possible configurations for the adaptive layer include non-local operations, dilated convolutions, an inception architecture, or otherwise. By reshaping the 3D feature maps at each resolution to a common number of 3D channels, 3D refinement modules 160A-C can combine 3D feature maps of different resolutions using an element-wise summation. In this manner, 3D refinement modules 160A-C can recursively aggregate local and global detail from multiple resolutions of 3D feature maps.

Generally, each of the adaptive layers is configured to reshape the 3D feature maps to any desired channels. In some embodiments, the adaptive layers are configured to reshape the 3D feature maps to have the same channel as the input 3D volume 105, which may be represented in multiple modalities. As such, a multi-class classifier (e.g., softmax classifier 170 or other suitable classifier) can be applied to the output of the final layer (e.g., 3D refinement module 160A), for example at each voxel, to achieve a multi-class, voxel-wise prediction 180.

Although 3D segmentation network 100 is illustrated with a particular architecture (e.g., four convolutional blocks, three 3D refinement modules, softmax classifier), any suitable variation may be implemented. For example, any number of convolutional blocks and/or 3D refinement modules may be implemented, and on any portion of a 3D segmentation network. In some embodiments, all convolutional blocks except the lowest resolution block are paired with a 3D refinement module, but this need not be the case. Generally, outputs from any two convolutional blocks and/or convolutional layers can be combined with a 3D refinement module. Furthermore, a 3D refinement module need not combine outputs from successive convolutional blocks and/or convolutional layers, and may alternatively combine outputs from non-successive convolutional blocks and/or convolutional layers. Furthermore, although the 3D refinement modules in FIG. 1 are illustrated as combining outputs from two convolutional blocks, in some embodiments, a 3D refinement module can combine outputs from any number of convolutional blocks.

Generally, 3D segmentation network 100 can be used to perform any type of 3D segmentation task. 3D segmentation has applicability in a number of fields, including medical application, object/collision detection, detection of weather patterns, machine vision, recognition tasks, and otherwise. In the medical field, for example, 3D segmentation network 100 can be performed to detect tumors from any part of the body (e.g., brain, breast, colon, esophageal, liver, pancreas, eye, kidney, blood, bone, lung, skin, etc.), to identify different regions of any part of the body, or lesions thereof, and the like. Generally, 3D segmentation has a growing number of practical applications, both within the medical field and elsewhere.

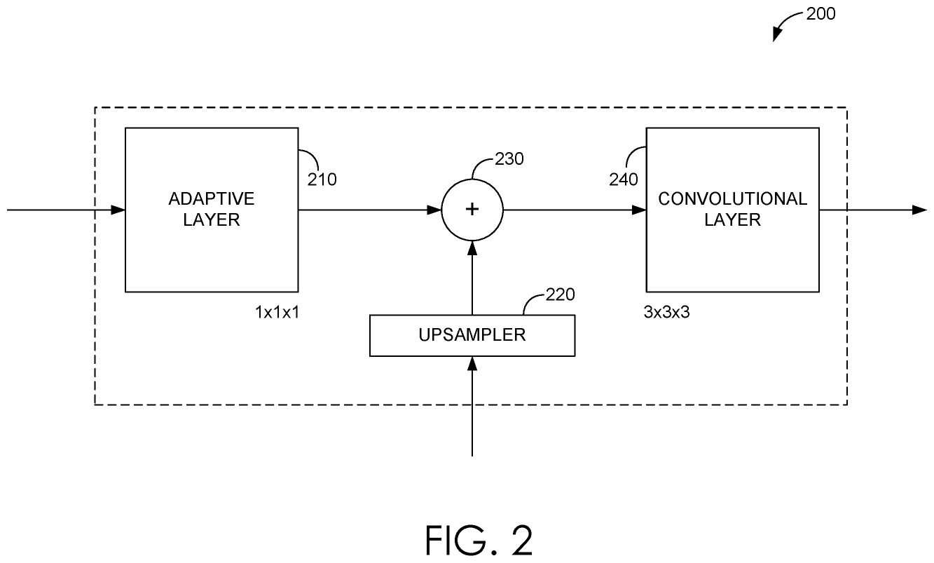

Turning now to FIG. 2, FIG. 2 illustrates an example 3D refinement module 200, in accordance with embodiments of the present disclosure. 3D refinement module 200 may correspond with 3D refinement modules 160A-C of FIG. 1. Generally, 3D refinement module 200 includes adaptive layer 210, upsampler 220, element-wise summation 230, and convolutional layer 240.

Adaptive layer 210 may be a convolutional layer configured to reshape 3D feature maps from a particular number of 3D channels. Adaptive layer 210 may be tailored to map a number of input channels to any number of output channels, for example, by selecting an appropriate kernel size. In some embodiments, adaptive layer 210 can be implemented using a 1×1×1 kernel. However, any suitable configuration may be implemented for the adaptive layer, including the use of non-local operations, dilated convolutions, an inception architecture, and others. Upsampler 220 generally performs an upsampling operation that increases the resolution of a set of 3D feature maps. Upsampler 220 may include a convolution with a corresponding input stride (e.g., a backwards convolution with a corresponding output stride). Generally, adaptive layer 210 reshapes a set of 3D feature maps at one resolution to have the same number of 3D channels as the output of upsampler 220, which may be at another resolution. As such, the aligned 3D feature maps can be combined using element-wise summation 230. In some embodiments, 3D refinement module 200 includes convolutional layer 240 and may use any suitable kernel size (e.g., 3×3×3). Generally, convolution layer 240 can perform a smoothing function to reduce undesirable artifacts in combined feature maps.

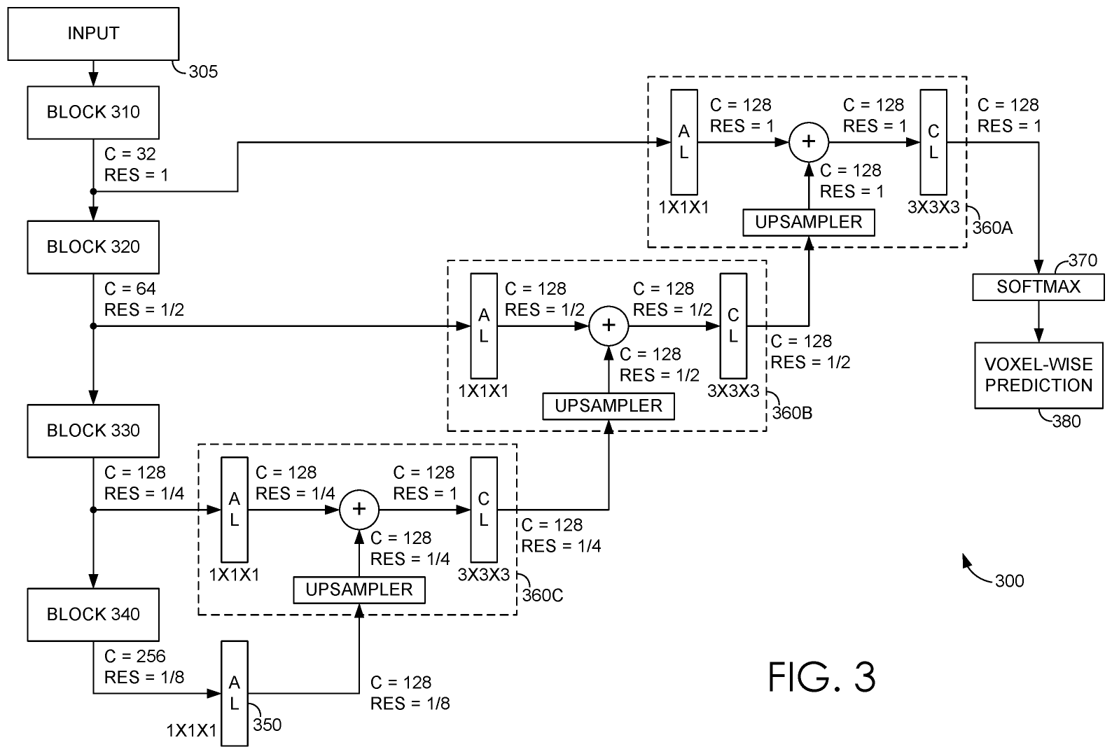

Turning now to another figure, FIG. 3 illustrates example tumor 3D segmentation network 300 that can be used to detect tumors, e.g., brain tumors, from MRIs. The components illustrated in FIG. 3 can correspond to the components illustrated in FIGS. 1 and 2. Generally, tumor 3D segmentation network 300 includes convolutional blocks 310-340, adaptive layer 350, 3D refinement modules 360A-C, and softmax classifier 370. Tumor 3D segmentation network 300 may accept input 305 (e.g., multiple MRI modalities) illustrating a region of a brain in corresponding 3D input channels. Each of MRI modalities can be constructed as a 3D volume that represents a region of the brain. In some embodiments, one or more of MRI modalities can represent a 3D region of the brain. Additionally or alternatively, one or more of MRI modalities can represent changes over time, for example, by stacking frames (e.g., MRI slices) of an MRI video to construct a 3D volume. In some embodiments, the four 3D MRI modalities are T1, T1-contrast, T2, and FLAIR. Generally, any number of 3D volumes can be constructed to represent any 2D and/or 3D region of a brain.

In one embodiment, tumor 3D segmentation network 300 can perform a 3D segmentation of the region of the brain depicted in input 305. For example, softmax classifier 370 can be configured to predict five labels (four tumor tissues and normal tissue) at each voxel. In some embodiments, the four tumor tissues are necrotic core, edema, non-enhancing and enhancing core. As such, in this example, softmax classifier 370 can generate voxel-wise prediction 380 segmenting the region of the tissues depicted in input 305. In one instance, it is a five-class voxel-wise prediction that segments the brain tissues into five different classes.

For illustration purposes, the outputs of the various components of FIG. 3 are annotated with an example number of 3D channels (C) and relative resolution values (RES). For example, in FIG. 3, blocks 310-340 operate to downsample to relative resolutions of {1, ½, ¼, ⅛} and output {32, 64, 128, 256} 3D channels, respectively. Adaptive layers in each of 3D refinement modules 360A-C, as well as adaptive layer 350, reshapes the number of 3D channels to 128. Upsamplers in each of 3D refinement modules 360A-C perform a 2× upsampling operation on lower resolution 3D feature maps. As a result, in one embodiment, tumor 3D segmentation network 300 produces 128-channel 3D feature maps from the last refined convolutional layer, and the final 3D feature map has the same shape as the input 3D volume represented by the MRI inputs. As such, softmax classifier 370 can perform a voxel-wise segmentation of the input 3D volume.

### Example Training Techniques

Generally, an efficient training approach can be implemented in order to improve the accuracy of a 3D segmentation network. In situations where training datasets are sparse, various techniques can be applied to nevertheless train an accurate 3D segmentation network. As such, in some embodiments, a training strategy can be implemented by incorporating one or more of curriculum learning, focal loss, and data augmentation. Any or all of these techniques can individually and/or in combination result in improved performance.

As described above, a 3D segmentation task can be considered a dense (e.g., per-voxel) classification problem. Accordingly, during training, the training loss of a 3D segmentation network can be computed densely over all spatial-temporal locations in a 3D MRI volume. This can give rise to a number of implications. For example, dense 3D training generates a large number of redundant training samples by learning from neighboring locations in spatial and temporal domains. These samples are closely related with less diversity, and thus are less informative. Furthermore, training would be highly inefficient when most sampling locations are easy classifications, which would result in inefficient learning. This often occurs during dense 2D image detection, and becomes more significant for 3D segmentation. As such, a training strategy can be implemented to address these implications by incorporating one or more of curriculum learning, focal loss, and data augmentation.

In some embodiments, cross-entropy loss can be replaced with focal loss as the minimization function in the softmax classifier. Generally, using automatically-selected meaningful samples can assist in training a high-capability model for a dense training task. By introducing a modulating factor (Υ) to the cross entropy loss and/or a parameter (α) for class balancing, the resulting focal loss down-weights easy samples and emphasizes learning from a sparse set of hard samples. This naturally alleviates the negative impact from a large number of easy samples, leading to performance boost.

Formally, focal loss can be defined by introducing a modulating factor (Υ) to the cross entropy loss and/or a parameter (α) for class balancing: FL(pₜ)=−α(1−pₜ)^{Υ} log(pₜ), where (1−pₜ)^{Υ} is the modulating factor, −log(pₜ) is the cross-entropy loss. Here, pₜ=p if y=1, and otherwise pₜ=1−p, where y∈{−1, +1] is the ground-truth class, and p∈[0, 1] is the estimated probability for the class with label y=1. As such, Υ is a focusing parameter, and the focal loss is equal to original cross entropy loss when Υ=0, and training focuses on hard samples when Υ>0. Applying focal loss down-weights easy samples which have a high value of pₜ, indicating a high estimated probability for the correct class. A larger value of Υ means more contribution from the hard samples to the training process. As such, using focal loss can provide a simple formulation that allows a 3D segmentation network to automatically select a set of meaningful samples for learning.

In some embodiments, data augmentation can be applied to increase the amount of training data available. For example, in embodiments which involve operations on 3D MRIs, training data comprising 3D volumetric MRIs can be sparse. Data augmentation facilitates generation of large amounts of training data with increased diversity. Generally, data augmentation may be implemented in any manner. For example, a simple slice-level augmentation can be implemented by randomly amplifying color values. Additionally or alternatively, volume-level augmentation can be applied using random operations through some or all slices within a volume. For example, slices can be rotated with a random orientation (e.g., from −90° to +90°), slices can be re-scaled using a random ratio (e.g., from 0:7 to 1:3), horizontal and/or vertical flipping can be implemented (e.g., sequentially) with any designated probability (e.g., 50% for each operation), a random spatial cropping can be produced, and the like. In the latter scenario, each cropped region advantageously includes the whole region of tumor presented in a particular slice.

Generally, focal loss and data augmentation can encourage a 3D segmentation network to learn from data with more diversity and complexity. However, directly applying these techniques to a 3D segmentation network may not result in significant performance gains absent a designated learning curriculum. Generally, curriculum learning encourages learning by gradually increasing the complexity of learning tasks. As such, a multi-stage learning curriculum can be implemented to facilitate increased performance. In some embodiments, a three-stage learning curriculum can be implemented. In a first stage, a 3D segmentation network can be trained using an original dataset without data augmentation or focal loss. In a second stage, data complexity can be increased by applying data augmentation (e.g., to original videos, probability of 50%). In a third stage, a 3D segmentation network can be trained to emphasize harder samples by employing focal loss with stronger data augmentation (e.g., applied to 75% of training volumes). This multi-stage curriculum can facilitate stronger generalization and increased performance.

### Exemplary Flow Diagrams

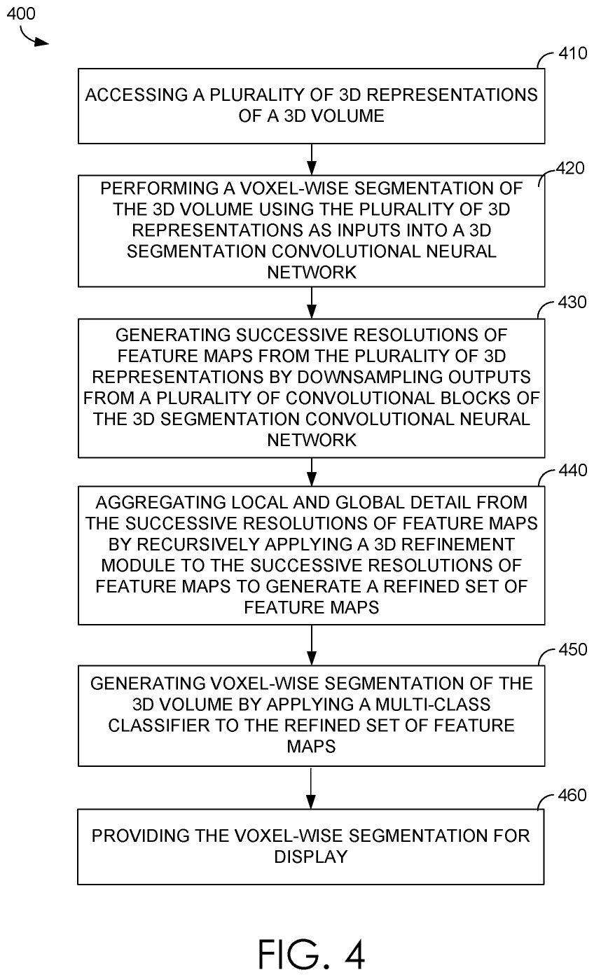

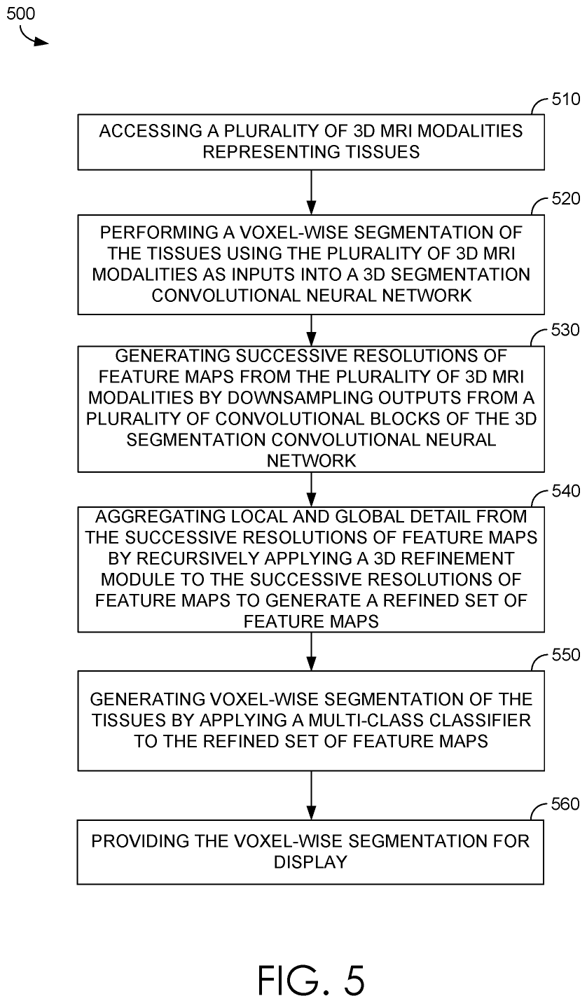

With reference now to FIGS. 4-5, flow diagrams are provided illustrating methods for 3D segmentation. Each block of the methods 400 and 500 and any other methods described herein comprise a computing process performed using any combination of hardware, firmware, and/or software. For instance, various functions can be carried out by a processor executing instructions stored in memory. The methods can also be embodied as computer-usable instructions stored on computer storage devices. The methods can be provided by a standalone application, a service or hosted service (standalone or in combination with another hosted service), or a plug-in to another product, to name a few.

Turning initially to FIG. 4, FIG. 4 illustrates a method 400 for generating voxel-wise segmentation of a 3D volume, in accordance with embodiments described herein. Initially, at block 410, a plurality of 3D representations of a 3D volume are accessed. At block 420, a voxel-wise segmentation of the 3D volume is performed using the plurality of 3D representations as inputs into a 3D segmentation convolutional neural network. The voxel-wise segmentation comprises, at block 430, generating successive resolutions of feature maps from the plurality of 3D representations by downsampling outputs from a plurality of convolutional blocks of the 3D segmentation convolutional neural network. The voxel-wise segmentation further comprises, at block 440, aggregating local and global detail from the successive resolutions of feature maps by recursively applying a 3D refinement module to the successive resolutions of feature maps to generate a refined set of feature maps. The voxel-wise segmentation further comprises, at block 450, generating voxel-wise segmentation of the 3D volume by applying a multi-class classifier to the refined set of feature maps. At block 460, the voxel-wise segmentation is provided for display, e.g., via various displaying devices and technologies. In some embodiments, the display of the voxel-wise segmentation may advantageously facilitate physicians to make more accurate diagnoses, avoid overdiagnosis, or determine the prognosis. Further, during a surgical procedure, the voxel-wise segmentation, achieved with the disclosed technologies, may guide surgeons to remove tumors with added precision.

Turning now to FIG. 5, FIG. 5 illustrates a method 500 for generating voxel-wise tumor segmentation of tissues, in accordance with embodiments described herein. Initially, at block 510, a plurality of 3D MRI modalities representing the tissues are accessed. At block 520, a voxel-wise segmentation of the tissues is performed using the plurality of 3D MRI modalities as inputs into a 3D segmentation convolutional neural network. The voxel-wise segmentation of the tissues includes, at block 530, generating successive resolutions of feature maps from the plurality of 3D MRI modalities by downsampling outputs from a plurality of convolutional blocks of the 3D segmentation convolutional neural network. The voxel-wise segmentation of the tissues includes, at block 540, aggregating local and global detail from the successive resolutions of feature maps by recursively applying a 3D refinement module to the successive resolutions of feature maps to generate a refined set of feature maps. The voxel-wise segmentation of the tissues includes, at block 550, generating voxel-wise tumor segmentation of the tissues by applying a multi-class classifier to the refined set of feature maps. At block 560, the voxel-wise tumor segmentation is provided for display.

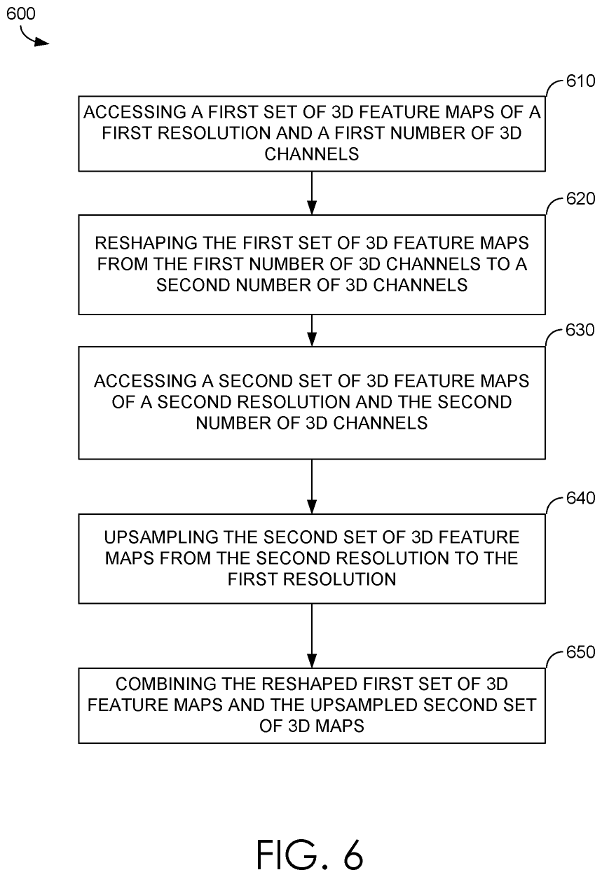

Turning now to another figure, FIG. 6 illustrates a method 600 for combining 3D feature maps of different resolutions, in accordance with embodiments described herein. Initially at block 610, a first set of 3D feature maps of a first resolution and a first number of 3D channels are accessed. At block 620, the first set of 3D feature maps are reshaped from the first number of 3D channels to a second number of 3D channels. At block 630, a second set of 3D feature maps of a second resolution and the second number of 3D channels are accessed. At block 640, the second set of 3D feature maps are upsampled from the second resolution to the first resolution. At block 650, the reshaped first set of 3D feature maps and the upsampled second set of 3D maps are combined.

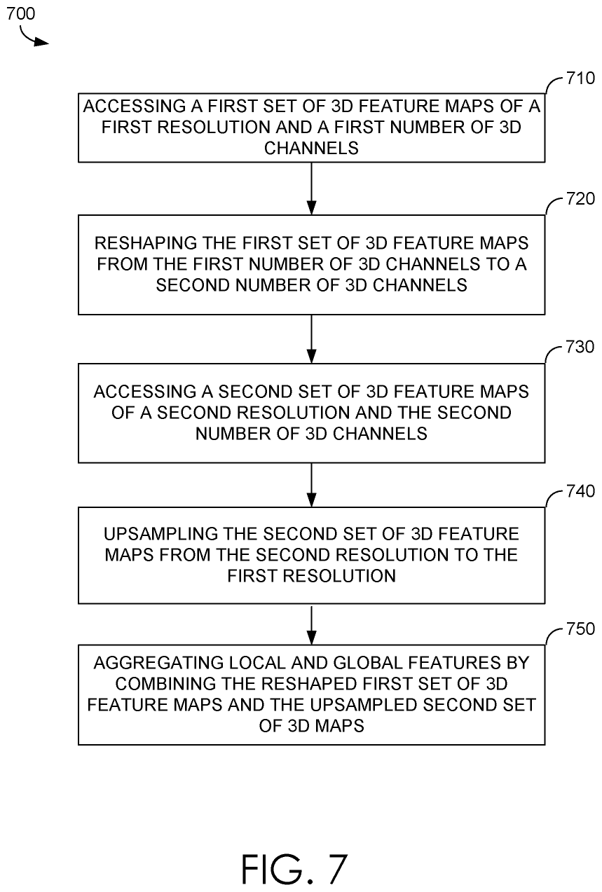

Turning now to another figure, FIG. 7 illustrates a method 700 for combining 3D feature maps of different resolutions, in accordance with embodiments described herein. Initially at block 710, a first set of 3D feature maps of a first resolution and a first number of 3D channels are accessed. At block 720, the first set of 3D feature maps are reshaped from the first number of 3D channels to a second number of 3D channels. At block 730, a second set of 3D feature maps of a second resolution and the second number of 3D channels are accessed. At block 740, the second set of 3D feature maps are upsampled from the second resolution to the first resolution. At block 750, local and global features are aggregated by combining the reshaped first set of 3D feature maps and the upsampled second set of 3D maps.

### Exemplary Operating Environment

Having described an overview of embodiments of the present invention, an exemplary operating environment in which embodiments of the present invention may be implemented is described below in order to provide a general context for various aspects of the present invention. Referring now to FIG. 8 in particular, an exemplary operating environment for implementing embodiments of the present invention is shown and designated generally as computing device 800. Computing device 800 is but one example of a suitable computing environment and is not intended to suggest any limitation as to the scope of use or functionality of the invention. Neither should computing device 800 be interpreted as having any dependency or requirement relating to any one or combination of components illustrated.

The invention may be described in the general context of computer code or machine-useable instructions, including computer-executable instructions such as program modules, being executed by a computer or other machine, such as a cellular telephone, personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 8, computing device 800 includes bus 810 that directly or indirectly couples the following devices: memory 812, one or more processors 814, one or more presentation components 816, input/output (I/O) ports 818, input/output components 820, and illustrative power supply 822. Bus 810 represents what may be one or more busses (such as an address bus, data bus, or combination thereof). Although the various blocks of FIG. 8 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventor recognizes that such is the nature of the art, and reiterates that the diagram of FIG. 8 is merely illustrative of an exemplary computing device that can be used in connection with one or more embodiments of the present disclosure. Distinction is not made between such categories as “workstation,” “server,” “laptop,” “hand-held device,” etc., as all are contemplated within the scope of FIG. 8 and reference to “computing device.”

Computing device 800 typically includes a variety of computer storage devices, also known as computer-readable media. Computer-readable media can be any available media that can be accessed by computing device 800 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer-storage media in the form of volatile and/or nonvolatile memory. The memory may be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

In various embodiments, memory 812 includes, in particular, temporal and persistent copies of special instructions 830. Special instructions 830 includes instructions that, when executed by one or more processors 814, result in computing device 800 performing segmentation functions, such as, but not limited to, process 400, 500, 600, and 700. In various embodiments, special instructions 830 includes instructions that, when executed by processors 814, result in computing device 800 performing various functions associated with, but not limited to, various components illustrated in FIGS. 1-3.

In some embodiments, one or more processors 814 may be packaged together with special instructions 830. In some embodiments, one or more processors 814 may be packaged together with special instructions 830 to form a System in Package (SiP). In some embodiments, one or more processors 814 can be integrated on the same die with special instructions 830. In some embodiments, processors 814 can be integrated on the same die with special instructions 830 to form a System on Chip (SoC).

I/O ports 818 allow computing device 800 to be logically coupled to other devices including I/O components 820, some of which may be built in. Illustrative components include a microphone, joystick, game pad, satellite dish, scanner, printer, wireless device, etc. The I/O components 820 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of computing device 800. Computing device 800 may be equipped with depth cameras, such as stereoscopic camera systems, infrared camera systems, RGB camera systems, touchscreen technology, and combinations of these, for gesture detection and recognition. Additionally, the computing device 800 may be equipped with accelerometers or gyroscopes that enable detection of motion. The output of the accelerometers or gyroscopes may be provided to the display of computing device 800 to render immersive augmented reality or virtual reality.

Embodiments described herein support 3D segmentation. The components described herein refer to integrated components of a 3D segmentation network. The integrated components refer to the hardware architecture and software framework that support functionality for the 3D segmentation network. The hardware architecture refers to physical components and interrelationships thereof, and the software framework refers to software providing functionality that can be implemented with hardware embodied on a device.

An end-to-end software-based system can operate within the 3D segmentation network components to operate computer hardware to provide system functionality. At a low level, hardware processors execute instructions selected from a machine language (also referred to as machine code or native) instruction set for a given processor. The processor recognizes the native instructions and performs corresponding low level functions relating, for example, to logic, control, and memory operations. Low level software written in machine code can provide more complex functionality to higher levels of software. As used herein, computer-executable instructions include any software, including low level software written in machine code, higher level software such as application software, and any combination thereof. In this regard, the components can manage resources and provide services for the system functionality. Any other variations and combinations thereof are contemplated with embodiments of the present invention.

Having identified various components in the present disclosure, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, groupings of functions, etc.) can be used in addition to or instead of those shown.

The subject matter of the present invention is described with specificity herein to meet statutory requirements. However, the description itself is not intended to limit the scope of this patent. Rather, the inventor has contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this disclosure is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

### EXAMPLES

According to various embodiments, the following examples describe a 3D refinement module and a 3D segmentation network. Examples 1-20 are directed to a 3D refinement module and related methods. Examples 21-40 are directed to a 3D segmentation network and related methods.

Example 1 is a method or a computer storage media storing computer-useable instructions that cause a computer to perform the method. The method may be implemented by a 3D refinement module or a 3D segmentation network. The operations of the method may include accessing a plurality of 3D representations of a 3D volume; performing a voxel-wise segmentation of the 3D volume using the plurality of 3D representations as inputs into a 3D segmentation convolutional neural network by: (1) generating successive resolutions of feature maps from the plurality of 3D representations by downsampling outputs from a plurality of convolutional blocks of the 3D segmentation convolutional neural network; (2) aggregating local and global detail from the successive resolutions of feature maps by recursively applying a 3D refinement module to the successive resolutions of feature maps to generate a refined set of feature maps; (3) generating voxel-wise segmentation of the 3D volume by applying a multi-class classifier to the refined set of feature maps; and (4) providing the voxel-wise segmentation for display.

Example 2 may include the subject matter of Example 1, wherein the 3D refinement module is configured to combine outputs from: an adaptive layer configured to reshape a first resolution set of the successive resolutions of feature maps to a designated number of 3D channels; and an upsampling operation performed on a lower resolution set of the successive resolutions of feature maps.

Example 3 may include the subject matter of Example 1 or 2, wherein the plurality of representations of the 3D volume comprise a plurality of 3D MRI modalities representing the tissues, and wherein the voxel-wise segmentation of the 3D volume comprises 3D segmentation of the tissues into a plurality of types of tumor tissues.

Example 4 may include any subject matter of Examples 1-3, and further includes training the 3D segmentation convolutional neural network using focal loss as a minimization function for the multi-class classifier.

Example 5 may include any subject matter of Examples 1-4, and further includes training the 3D segmentation convolutional neural network with augmented 3D volumetric Mills.

Example 6 may include any subject matter of Examples 1-5, and further includes training the 3D segmentation convolutional neural network using a multi-stage learning curriculum with successively increased data complexity.

Example 7 may include any subject matter of Examples 1-6, and further includes training the 3D segmentation convolutional neural network using a multi-stage learning curriculum comprising: a first training stage comprising training without using focal loss or data augmentation; a second training stage comprising training using data augmentation; and a third training stage comprising training using focal loss.

Example 8 is a method or a computer storage media storing computer-useable instructions that cause a computer to perform the method. The method may be used for 3D segmentation of tumors, e.g., brain tumors. The operations of the method may include accessing a plurality of 3D MRI modalities representing brain tissue; performing a voxel-wise segmentation of the brain tissue using the plurality of 3D MRI modalities as inputs into a 3D segmentation convolutional neural network by: (1) generating successive resolutions of feature maps from the plurality of 3D MRI modalities by downsampling outputs from a plurality of convolutional blocks of the 3D segmentation convolutional neural network; (2) aggregating local and global detail from the successive resolutions of feature maps by recursively applying a 3D refinement module to the successive resolutions of feature maps to generate a refined set of feature maps; (3) generating voxel-wise brain tumor segmentation of the brain tissue by applying a multi-class classifier to the refined set of feature maps; and (4) providing the voxel-wise brain tumor segmentation for display.

Example 9 may include the subject matter of Example 8, wherein the 3D refinement module is configured to combine outputs from: an adaptive layer configured to reshape a first resolution set of the successive resolutions of feature maps to a designated number of 3D channels; and an upsampling operation performed on a lower resolution set of the successive resolutions of feature maps.

Example 10 may include any subject matter of Examples 8-9, wherein the 3D refinement module comprises an adaptive layer configured to utilize a 1×1×1 kernel.

Example 11 may include any subject matter of Examples 8-10, and further includes training the 3D segmentation convolutional neural network using focal loss as a minimization function for the multi-class classifier.

Example 12 may include any subject matter of Examples 8-11, and further includes training the 3D segmentation convolutional neural network with augmented 3D volumetric Mills.

Example 13 may include any subject matter of Examples 8-12, and further includes training the 3D segmentation convolutional neural network using a multi-stage learning curriculum with successively increased data complexity.

Example 14 may include any subject matter of Examples 8-13, and further includes training the 3D segmentation convolutional neural network using a multi-stage learning curriculum comprising: a first training stage comprising training without using focal loss or data augmentation; a second training stage comprising training using data augmentation; and a third training stage comprising training using focal loss.

Example 15 is a computer system, which includes one or more hardware processors and memory configured to provide computer program instructions to the one or more hardware processors; a 3D segmentation convolutional neural network configured to utilize the one or more hardware processors to perform a 3D segmentation of brain tissue using a plurality of 3D MRI modalities representing the brain tissue as inputs by: (1) generating successive resolutions of feature maps from the plurality of 3D MRI modalities by downsampling outputs from a plurality of convolutional blocks; (2) aggregating local and global detail from spatial and temporal domains from the successive resolutions of feature maps by recursively applying a 3D refinement module to the successive resolutions of feature maps to generate a refined set of feature maps; (3) generating 3D brain tumor segmentation of the brain tissue by applying a multi-class classifier to the refined set of feature maps; and (4) providing the 3D brain tumor segmentation for display.

Example 16 may include the subject matter of Example 15, wherein the 3D refinement module is configured to combine outputs from: an adaptive layer configured to reshape a first resolution set of the successive resolutions of feature maps to a designated number of 3D channels; and an upsampling operation performed on a lower resolution set of the successive resolutions of feature maps.

Example 17 may include any subject matter of Examples 15-16, wherein the 3D refinement module comprises an adaptive layer configured to utilize a 1×1×1 kernel.

Example 18 may include any subject matter of Examples 15-17, wherein the 3D segmentation convolutional neural network is further configured to learn using focal loss as a minimization function for the multi-class classifier.

Example 19 may include any subject matter of Examples 15-18, wherein the 3D segmentation convolutional neural network is further configured to learn from augmented 3D volumetric MRIs.

Example 20 may include any subject matter of Examples 15-19, wherein the 3D segmentation convolutional neural network is further configured to learn using a multi-stage learning curriculum comprising: (1) a first training stage comprising training without using focal loss or data augmentation; (2) a second training stage comprising training using data augmentation; and (3) a third training stage comprising training using focal loss.

Example 21 is a method or a computer storage media storing computer-useable instructions that cause a computer to perform the method. The method may be implemented by a 3D refinement module or a 3D segmentation network. The operations of the method may include accessing a plurality of 3D representations of a 3D volume; performing a voxel-wise segmentation of the 3D volume using the plurality of 3D representations as inputs into a 3D segmentation convolutional neural network by: (1) generating successive resolutions of feature maps from the plurality of 3D representations by downsampling outputs from a plurality of convolutional blocks of the 3D segmentation convolutional neural network; (2) aggregating local and global detail from the successive resolutions of feature maps by recursively applying a 3D refinement module to the successive resolutions of feature maps to generate a refined set of feature maps; (3) generating voxel-wise segmentation of the 3D volume by applying a multi-class classifier to the refined set of feature maps; and (4) providing the voxel-wise segmentation for display.

Example 22 may include the subject matter of Example 21, wherein the 3D refinement module is configured to combine outputs from: (1) an adaptive layer configured to reshape a first resolution set of the successive resolutions of feature maps to a designated number of 3D channels; and (2) an upsampling operation performed on a lower resolution set of the successive resolutions of feature maps.

Example 23 may include the subject matter of Example 21 or 22, wherein the plurality of representations of the 3D volume comprise a plurality of 3D MRI modalities representing brain tissue, and wherein the voxel-wise segmentation of the 3D volume comprises 3D segmentation of the brain tumor into a plurality of types of tumor tissues.

Example 24 may include any subject matter of Examples 21-23, wherein the 3D refinement module is configured to align a low resolution feature map with a high resolution feature map.

Example 25 may include any subject matter of Examples 21-24, and further includes training the 3D segmentation convolutional neural network using focal loss as a minimization function for the multi-class classifier.

Example 26 may include any subject matter of Examples 21-25, and further includes training the 3D segmentation convolutional neural network with augmented 3D volumetric MRIs.

Example 27 may include any subject matter of Examples 21-26, and further includes training the 3D segmentation convolutional neural network using a multi-stage learning curriculum comprising: (1) a first training stage comprising training without using focal loss or data augmentation; (2) a second training stage comprising training using data augmentation; and (3) a third training stage comprising training using focal loss.

Example 28 is a method or a computer storage media storing computer-useable instructions that cause a computer to perform the method. The method may be used for 3D segmentation of brain tumors. The operations of the method may include accessing a plurality of 3D MRI modalities representing brain tissue; performing a voxel-wise segmentation of the brain tissue using the plurality of 3D MRI modalities as inputs into a 3D segmentation convolutional neural network by: (1) generating successive resolutions of feature maps from the plurality of 3D MRI modalities by downsampling outputs from a plurality of convolutional blocks of the 3D segmentation convolutional neural network; (2) aggregating local and global detail from the successive resolutions of feature maps by recursively applying a 3D refinement module to the successive resolutions of feature maps to generate a refined set of feature maps; (3) generating voxel-wise brain tumor segmentation of the brain tissue by applying a multi-class classifier to the refined set of feature maps; and (4) providing the voxel-wise brain tumor segmentation for display.

Example 29 may include the subject matter of Example 28, wherein the 3D refinement module is configured to combine outputs from: (1) an adaptive layer configured to reshape a first resolution set of the successive resolutions of feature maps to a designated number of 3D channels; and (2) an upsampling operation performed on a lower resolution set of the successive resolutions of feature maps.

Example 30 may include any subject matter of Examples 28-29, wherein the 3D refinement module comprises an adaptive layer configured to utilize a 1×1×1 kernel.

Example 31 may include any subject matter of Examples 28-30, wherein the 3D refinement module is configured to align a low resolution feature map with a high resolution feature map.

Example 32 may include any subject matter of Examples 28-31, and further includes training the 3D segmentation convolutional neural network using focal loss as a minimization function for the multi-class classifier.

Example 33 may include any subject matter of Examples 28-32, and further includes training the 3D segmentation convolutional neural network with augmented 3D volumetric MRIs.

Example 34 may include any subject matter of Examples 28-33, and further includes training the 3D segmentation convolutional neural network using a multi-stage learning curriculum comprising: (1) a first training stage comprising training without using focal loss or data augmentation; (2) a second training stage comprising training using data augmentation; and (3) a third training stage comprising training using focal loss.

Example 35 is a computer system, which includes one or more hardware processors and memory configured to provide computer program instructions to the one or more hardware processors; a 3D segmentation convolutional neural network configured to utilize the one or more hardware processors to perform a 3D segmentation of brain tissue using a plurality of 3D MRI modalities representing the brain tissue as inputs by: (1) generating successive resolutions of feature maps from the plurality of 3D MRI modalities by downsampling outputs from a plurality of convolutional blocks; (2) aggregating local and global detail from spatial and temporal domains from the successive resolutions of feature maps by recursively applying a 3D refinement module to the successive resolutions of feature maps to generate a refined set of feature maps; (3) generating 3D brain tumor segmentation of the brain tissue by applying a multi-class classifier to the refined set of feature maps; and (4) providing the 3D brain tumor segmentation for display.

Example 36 may include the subject matter of Example 35, wherein the 3D refinement module is configured to combine outputs from: (1) an adaptive layer configured to reshape a first resolution set of the successive resolutions of feature maps to a designated number of 3D channels; and (2) an upsampling operation performed on a lower resolution set of the successive resolutions of feature maps.

Example 37 may include any subject matter of Examples 35-36, wherein the 3D refinement module comprises an adaptive layer configured to utilize a 1×1×1 kernel.

Example 38 may include any subject matter of Examples 35-37, wherein the 3D segmentation convolutional neural network is further configured to learn using focal loss as a minimization function for the multi-class classifier.

Example 39 may include any subject matter of Examples 35-38, wherein the 3D segmentation convolutional neural network is further configured to learn from augmented 3D volumetric MRIs.

Example 40 may include any subject matter of Examples 35-39, wherein the 3D segmentation convolutional neural network is further configured to learn using a multi-stage learning curriculum comprising: (1) a first training stage comprising training without using focal loss or data augmentation; (2) a second training stage comprising training using data augmentation; and (3) a third training stage comprising training using focal loss.

Various embodiments may include any suitable combination of the above-described embodiments including alternative embodiments that are described in conjunctive form (and) above (e.g., the “and” may be “and/or”). Furthermore, some embodiments may include one or more articles of manufacture (e.g., non-transitory computer-readable media) having instructions, stored thereon, that when executed result in actions of any of the above-described embodiments. Moreover, some embodiments may include apparatuses or systems having any suitable means for carrying out the various operations of the above-described embodiments.

The above description of illustrated implementations, including what is described in the Abstract, is not intended to be exhaustive or to limit the embodiments of the present disclosure to the precise forms disclosed. While specific implementations and examples are described herein for illustrative purposes, various equivalent modifications are possible within the scope of the present disclosure, as those skilled in the relevant art will recognize.

These modifications may be made to embodiments of the present disclosure in light of the above detailed description. The terms used in the following claims should not be construed to limit various embodiments of the present disclosure to the specific implementations disclosed in the specification and the claims. Rather, the scope is to be determined entirely by the following claims, which are to be construed in accordance with established doctrines of claim interpretation.

What is claimed is:

1. One or more non-transitory computer storage media storing computer-useable instructions that, when used by one or more computing devices, cause the one or more computing devices to perform operations comprising:
accessing a first set of 3D feature maps of a first resolution and a first number of 3D channels;
reshaping the first set of 3D feature maps from the first number of 3D channels to a second number of 3D channels;
accessing a second set of 3D feature maps of a second resolution and the second number of 3D channels;
upsampling the second set of 3D feature maps from the second resolution to the first resolution; and
combining the reshaped first set of 3D feature maps and the upsampled second set of 3D maps.

2. The media of claim 1, wherein reshaping the first set of 3D feature maps comprises using an adaptive layer with a 1×1×1 kernel.

3. The media of claim 1, wherein combining the reshaped first set of 3D feature maps and the upsampled second set of 3D maps is performed with an element-wise summation.

4. The media of claim 1, wherein combining the reshaped first set of 3D feature maps and the upsampled second set of 3D maps generates a set of combined 3D feature maps, the operations further comprising applying a smoothing layer to the set of combined 3D feature maps.

5. The media of claim 4, wherein the smoothing layer performs a 3D convolution with a 3×3×3 kernel.

6. The media of claim 1, the first set of 3D feature maps being generated by a first convolutional block of a 3D segmentation network, and the second set of 3D feature maps being generated by a second convolutional block of the 3D segmentation network.

7. The media of claim 1, further comprising applying the operations recursively in a 3D segmentation network.

8. A method for 3D segmentation of brain tumors, the method comprising:
accessing a first set of 3D feature maps of a first resolution and a first number of 3D channels;
reshaping the first set of 3D feature maps from the first number of 3D channels to a second number of 3D channels;
accessing a second set of 3D feature maps of a second resolution and the second number of 3D channels;
upsampling the second set of 3D feature maps from the second resolution to the first resolution; and
aggregating local and global features by combining the reshaped first set of 3D feature maps and the upsampled second set of 3D maps.

9. The method of claim 8, reshaping the first set of 3D feature maps comprises using an adaptive layer with a 1×1×1 kernel.

10. The method of claim 8, wherein combining the reshaped first set of 3D feature maps and the upsampled second set of 3D maps is performed with an element-wise summation.

11. The method of claim 8, wherein combining the reshaped first set of 3D feature maps and the upsampled second set of 3D maps generates a set of combined 3D feature maps, the operations further comprising applying a smoothing layer to the set of combined 3D feature maps.

12. The method of claim 11, wherein the smoothing layer performs a 3D convolution with a 3×3×3 kernel.

13. The method of claim 8, the first set of 3D feature maps being generated by a first convolutional block of a 3D segmentation network, and the second set of 3D feature maps being generated by a second convolutional block of the 3D segmentation network.

14. The method of claim 8, further comprising applying the method recursively in a 3D segmentation network.

15. A computer system, comprising:
one or more hardware processors and memory configured to provide computer program instructions to the one or more hardware processors;
an adaptive layer configured to utilize the one or more hardware processors to:
access a first set of 3D feature maps of a first resolution and a first number of 3D channels; and
reshape the first set of 3D feature maps from the first number of 3D channels to a second number of 3D channels;
an upsampler configured to utilize the one or more hardware processors to:
access a second set of 3D feature maps of a second resolution and the second number of 3D channels; and
upsample the second set of 3D feature maps from the second resolution to the first resolution; and
an element-wise summation configured to utilize the one or more hardware processors to combine the reshaped first set of 3D feature maps and the upsampled second set of 3D feature maps into a set of combined 3D feature maps.

16. The computer system of claim 15, wherein the first set of 3D feature maps and the second set of 3D feature maps are based on 3D volumetric Mills.

17. The computer system of claim 15, wherein the adaptive layer is further configured to reshape the first set of 3D feature maps using another adaptive layer with a 1×1×1 kernel.

18. The computer system of claim 15, further comprising a smoothing layer configured to smooth the set of combined 3D feature maps.

19. The computer system of claim 18, wherein the smoothing layer comprises a convolutional layer with a 3×3×3 kernel.

20. The computer system of claim 15, the first set of 3D feature maps being generated by a first convolutional block of a 3D segmentation network, and the second set of 3D feature maps being generated by a second convolutional block of the 3D segmentation network.
